(19) United States
(12) Patent Application Publication
(10) Pub. No.: US 2008/0304736 A1
(43) Pub. Date: Dec. 11, 2008

(54) METHOD OF ESTIMATING A VISUAL EVALUATION VALUE OF SKIN BEAUTY

(75) Inventors: Masahiro Nakagawa, Niigata (JP); Koji Mizukoshi, Kanagawa (JP); Midori Oyobikawa, Kanagawa (JP); Katsuo Matsomoto, Kanagawa (JP)

Correspondence Address: KNOBBE MARTENS OLSON & BEAR LLP, 2040 MAIN STREET, FOURTEENTH FLOOR, IRVINE, CA, 92614, US

(73) Assignees: Masahiro Nakagawa, Niigata (JP); Pola Chemical Industries Inc., Shizuoka (JP)

(21) Appl. No.: 11/861,910

(22) Filed: Sep. 26, 2007

(30) Foreign Application Priority Data
Feb. 20, 2007 (JP) 2007-039696

(51) Int. Cl. G06K 9/00

(52) U.S. Cl. 382/165

(57) ABSTRACT

A method of estimating a visual evaluation value of beauty of a skin, and a device and a program for calculating a visual evaluation value of beauty of a skin are provided. Anybody can easily estimate a visual evaluation value of beauty of a skin objectively and quantitatively. A visual evaluation value of beauty of the skin is estimated by using a correlation between a visual evaluation value of beauty of the skin and a fractal dimension of a distribution of a color system signal of an image of the skin or a 3-dimensional skin surface relief value of a skin surface.

### TECHNICAL FIELD

The present invention relates to a technology of estimating a visual evaluation value of beauty of a skin, and more particularly, to a technology of estimating a visual evaluation value of beauty of a skin by using a fractal dimension of a property value of the skin as an index.

### BACKGROUND ART

It is one of great wishes not only for women but also for many people that their skins be recognized to be beautiful by a third person. Thus, research and development have been actively conducted on cosmetics and beautification techniques or methods to make a skin look beautiful. However, skin conditions greatly vary from individual to individual, and change with aging or according to a living environment. Thus, to properly select a type of cosmetics, a makeup method, or a skin treatment method, it is necessary to objectively evaluate how a target skin looks to a third person. For example, at a store such as a cosmetic selling floor of a department store, a drugstore, or a cosmetic store, a simple method of evaluating a level of skin beauty of a test subject is required.

Various studies have been conducted on elements of visual skin beauty, and a method of evaluating each part of the elements has been developed. For example, there is a method of evaluating characteristics of a skin by using a technology of measuring a physical quantity such as skin conductance, trans epidermal water loss, sebum quantity, skin flexibility or, turnover speed of a stratum corneum. Recently, a method of processing image information obtained by imaging a skin surface or its replica by proper photoelectric conversion means by a program to quantitatively evaluate a skin surface shape or optical characteristics has been reported.

However, when the third person sees the skin, a skin condition visually recognized by the third person, in other words, visual beauty of a skin, is formed in association with a complex combination of numerous elements, so it is not easy to evaluate the visual beauty of a skin based on the measured result of each of the elements. In practice, to determine visual skin beauty, an expert in skin evaluation has to analyze a measured result based on expertise, or assessors have to make sensory evaluation by making paired comparison visually. In this case, however, an expert in skin evaluation and a fixed number or more of assessors are necessary. Besides, collected evaluation data needs to be analyzed. Thus, it is difficult to accurately and easily evaluate the visual beauty of a skin by the conventional method.

According to such a background art, an attempt has been made to evaluate beauty of the skin by measuring and processing a specific skin property value obtained from a skin photograph or a replica, and finding a correlation between the measurement value or processing value and the beauty of the skin. For example, the following methods have been disclosed: a method of applying visible lights to a skin replica from two directions and identifying beauty of a skin by using a reflectance at each wavelength of a reflected light spectrum of the skin as an index (Patent Document 1), a method of identifying beauty of a face line by using a thickness of subcutaneous fat around the face line and a restoring force from deformation caused by an external force as indices (Patent Document 2), a method of numerically expressing optical beauty of a skin surface by using a correlation between a particle analysis value of a high luminance part of a two-dimensional image in which a fine brightness distribution in the skin surface is intensified and sensory evaluation of visual beauty of a skin (Patent Document 3), a method of identifying a skin by using a difference in optical spectrum between reflected lights obtained by applying visible lights to a made-up skin from two directions (Patent Document 4), and a method of evaluating beauty of a skin by using a correlation between a diffusion value of a high-frequency component of a mirror-reflected light component contained in a digital image of the skin obtained under polarized lighting and sensual evaluation of the beauty of skin (Patent Document 5). According to these technologies, a relation between a measurement value or a processing value and the beauty of skin is recognized to a certain extent, however, their correlation is not always high. Thus, research and clarification as to what a numerical value indicating skin characteristics having a high correlation with skin beauty is have yet to be made, and a numerical value indicating a higher utilization value as an index for evaluating skin beauty has been sought after.

On the other hand, a fractal concept is a geometric concept used for self-similar graphics created in research of a mathematical field. In the natural world, many having fractal shapes are known to exist. According to one of known means for expressing a shape having a fractal nature, a fractal dimension is obtained. Recently, a method of determining a specific condition of a living organism by calculating a fractal dimension has been reported. For example, the following methods and a system have been disclosed: a method of subjecting a bio-signal of a characteristic anxiety level of a test subject to fractal analysis, and evaluating an anxiety level based on a correlation between the analytic value and statistical data (Patent Document 6), a method of investigating a condition of a tissue by subjecting a reflected ultrasonic pulse signal from the tissue to fractal analysis (Patent Document 7), and an automatic detection system of malignant cells which uses fractal analysis (Patent Document 8).

Additionally, a method of evaluating a melanin pigment distribution of a skin based on a correlation between a pigment distribution of melanin or the like and a fractal dimension of luminance of pixels constructing a skin image has been disclosed (Patent Document 9). It has been reported that use of a fractal dimension of a skin property value as an index may enable estimation of a skin age (Non-patent Document 1). However, a specific method of using a fractal dimension is yet to be clarified. A relation between a fractal dimension and a skin age, and a relation between a fractal dimension and a visual evaluation value are yet to be elucidated.

[Patent Document 1] JP 2003-161656 A

[Patent Document 2] JP 11-164822 A

[Patent Document 3] JP 7-231883 A

[Patent Document 4] JP 10-2798 A

[Patent Document 5] JP 2005-429 A

[Patent Document 6] JP 2001-299702 A

[Patent Document 7] JP 11-507846 A

[Patent Document 8] JP 2001-512824 A

[Patent Document 9] JP 2000-135207 A

[Non-patent Document 1] “Skin Age Estimation Method Using Feature Amount of Skin Image and Corresponding Application to Skin Aging Prevention” (Masao Kasuga, Issued form Four Universities of Metropolitan North Area, New Technology Briefing, Dec. 2 of 2005, Explanatory Material).

### DISCLOSURE OF THE INVENTION

The present invention provides a method of estimating a visual evaluation value of beauty of a skin, and a device and a program for calculating a visual evaluation value of beauty of a skin so that anybody can easily estimate the visual evaluation value of beauty of a skin objectively and quantitatively. The present invention also provides a method of accurately obtaining a visual evaluation value of beauty of a skin by discovering a skin property value related to a visual evaluation value of beauty of a skin by a third person and its processing means.

The inventors have repeatedly conducted studies on beauty of a skin, and accordingly discovered that there is a cause-and-effect relation between a visual evaluation value of the skin beauty and a fractal dimension of various skin property values. Then, the inventors have discovered that a result very close to an actual visual evaluation value of beauty of a skin by a third person can be obtained by estimating a visual evaluation value of beauty of a skin from a fractal dimension of a skin of a test subject using the aforementioned relation, and have completed the invention.

The present invention is summarized as follows.

(1) A method of estimating a visual evaluation value of beauty of a skin, comprising the steps of:

obtaining an image signal of at least one color system of an image of a surface of the skin;

calculating a fractal dimension of a distribution of at least one of components of the image signal of the color system in the image; and

substituting the numerically calculated fractal dimension for a prepared regression equation indicating a relation between a fractal dimension of a distribution of the component and a visual evaluation value of beauty of a skin to obtain a visual evaluation value of beauty of the skin.

(2) The method according to item 1, wherein the image signal of the color system is one selected from RGB value, YUV value, and Munsell (HVC) value.

(3) The method according to item 1 or 2, wherein the regression equation is obtained by subjecting a fractal dimension of a distribution of each component of one selected from RGB value, YUV value, and Munsell (HVC) value and a visual evaluation value of beauty of a skin to a multiple regression analysis.

(4) A method of estimating a visual evaluation value of beauty of a skin, comprising the steps of:

obtaining a 3-dimensional skin surface relief value of a skin;

calculating a fractal dimension of a distribution of the 3-dimensional skin surface relief value; and

substituting the numerically calculated fractal dimension for a prepared regression equation indicating a relation between a fractal dimension of a distribution of the 3-dimensional skin surface relief value and a visual evaluation value of beauty of a skin to obtain a visual evaluation value of beauty of the skin.

(5) The method according to any one of items 1 to 4, wherein the fractal dimension is calculated by a box-counting method.

(6) The method according to item 5, wherein a box size in the box-counting method is decided based on a standard deviation of at least one of the components constructing the image signal of the color system in the box or the 3-dimensional skin surface relief value.

(7) A device for estimating a visual evaluation value of beauty of a skin, including:

means for obtaining an image signal of at least one color system of an image of a surface of the skin;

means for calculating a fractal dimension of a distribution of at least one of components of the image signal of the color system in the image;

means for substituting the numerically calculated fractal dimension for a prepared regression equation indicating a relation between a fractal dimension of a distribution of the component and a visual evaluation value of beauty of a skin to calculate a visual evaluation value of beauty of the skin; and

means for displaying the calculated visual evaluation value.

(8) A device for estimating a visual evaluation value of beauty of a skin, including:

means for obtaining a 3-dimensional skin surface relief value of a skin;

means for calculating a fractal dimension of a distribution of the 3-dimensional skin surface relief value;

means for substituting the numerically calculated fractal dimension for a prepared regression equation indicating a relation between a fractal dimension of a distribution of the 3-dimensional skin surface relief value and a visual evaluation value of beauty of a skin to calculate a visual evaluation value of beauty of the skin; and means for displaying the calculated visual evaluation value.

(9) A program for estimating a visual evaluation value of beauty of a skin, causing a computer to function as:

means for calculating a fractal dimension of a distribution of at least one of components of an image signal of a color system of an image of a surface of a skin in the image; and

means for substituting the numerically calculated fractal dimension for a prepared regression equation indicating a relation between a fractal dimension of a distribution of the component and a visual evaluation value of beauty of a skin to calculate a visual evaluation value of beauty of the skin.

(10) A program for estimating a visual evaluation value of beauty of a skin, causing a computer to function as:

means for calculating a fractal dimension of a distribution of a 3-dimensional skin surface relief value of a skin; and

means for substituting the numerically calculated fractal dimension for a prepared regression equation indicating a fractal dimension of a distribution of the 3-dimensional skin surface relief value and a visual evaluation value of beauty of a skin to calculate a visual evaluation value of beauty of the skin.

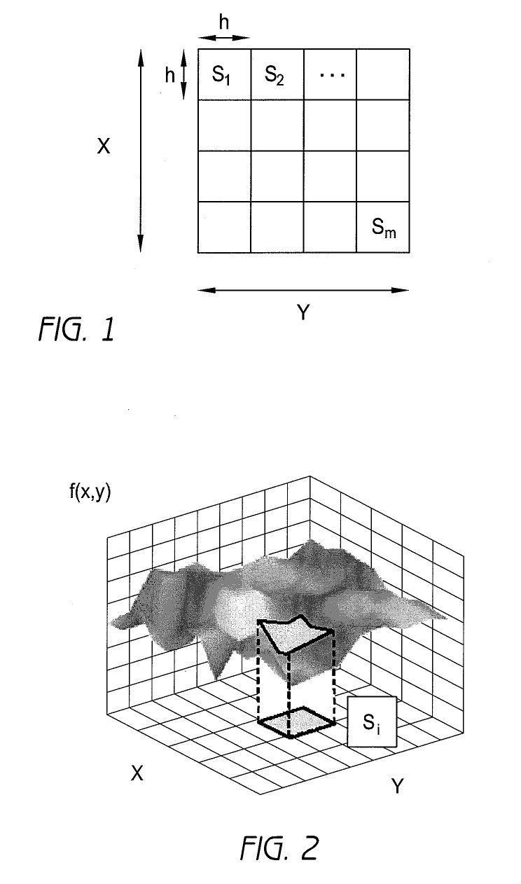

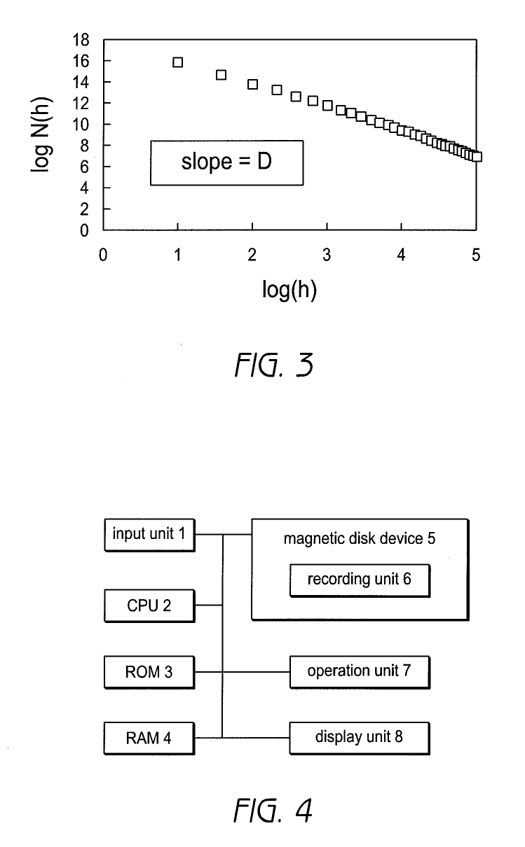

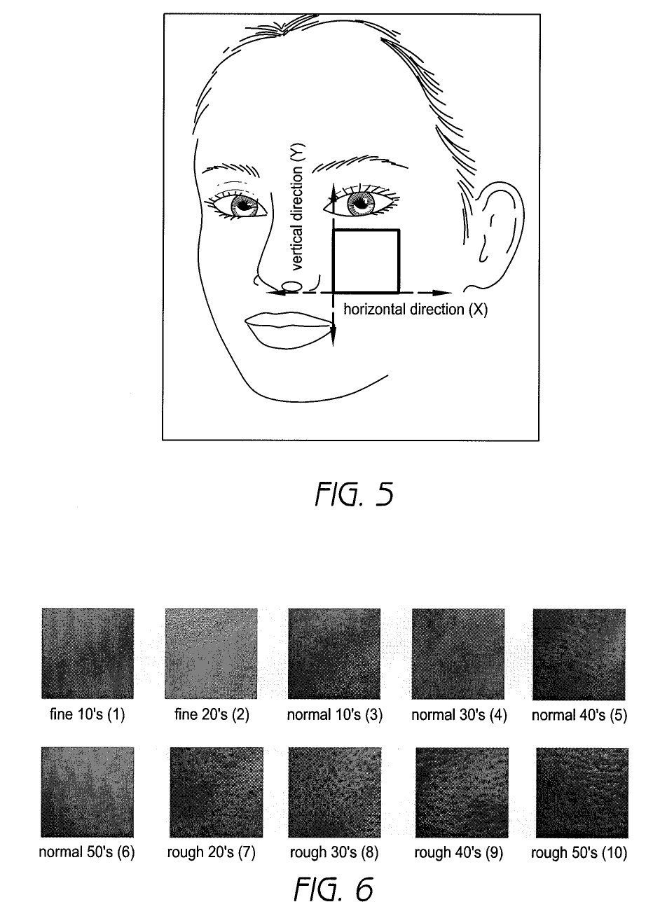

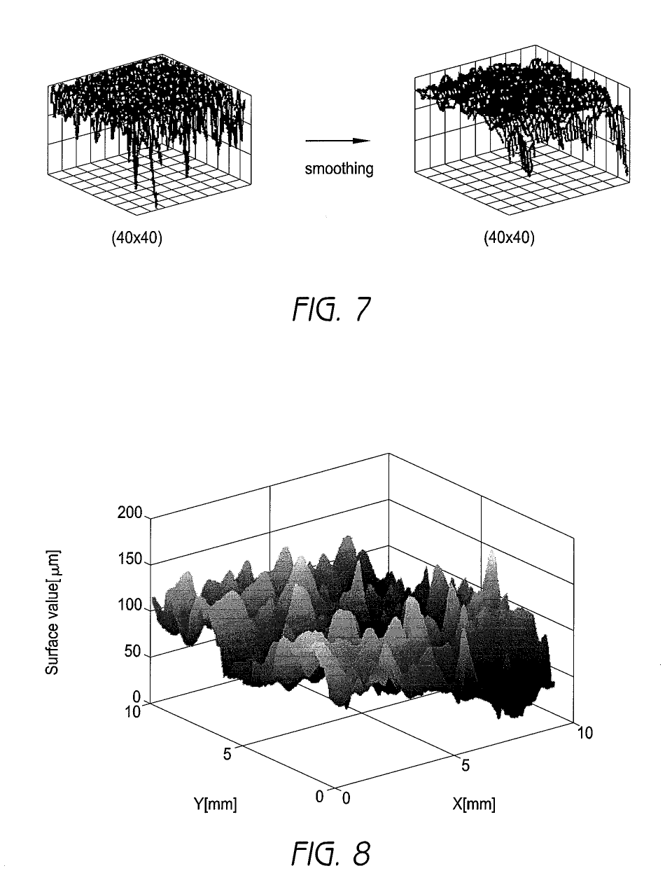

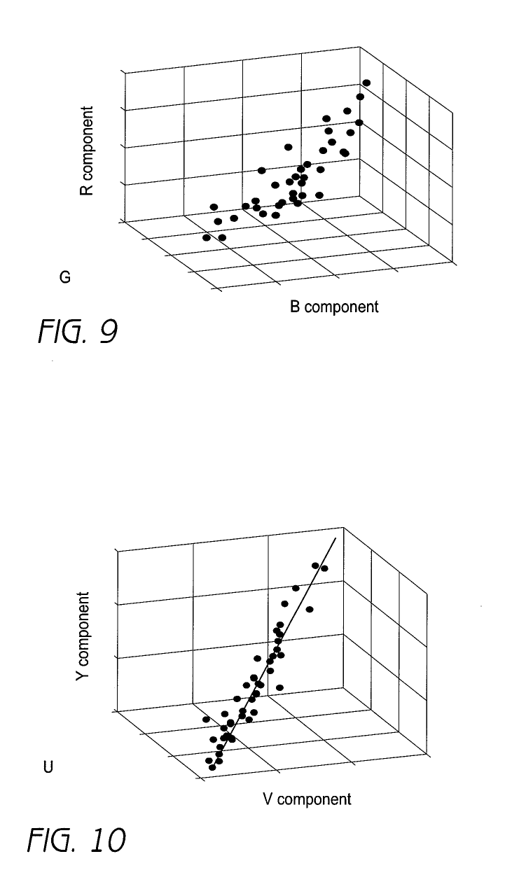

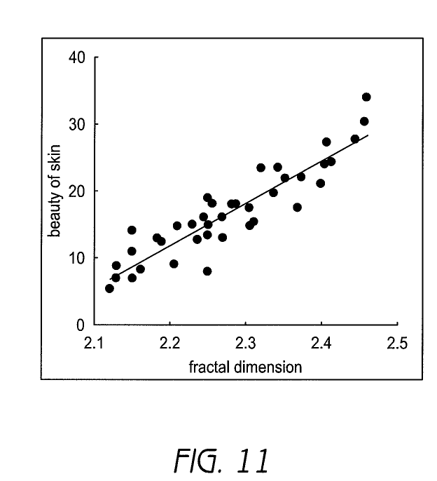

### BRIEF DESCRIPTION OF THE DRAWINGS

[FIG. 1] A diagram showing a division concept of a box-counting method.

[FIG. 2] A diagram showing a counting concept of the box-counting method.

[FIG. 3] A diagram showing a fractal dimension.

[FIG. 4] A hardware block diagram showing an example of a device for estimating a visual evaluation value of beauty of a skin according to the present invention.

[FIG. 5] A diagram showing an example of a measuring target area of a face.

[FIG. 6] A diagram showing an example of a cheek photograph used for evaluation of the present invention (photograph).

[FIG. 7] A diagram showing a smooth processing method of image data (mask size 3*3).

[FIG. 8] A diagram showing a 3-dimensional skin surface relief value data obtained from a replica and corrected based on the Sinc function.

[FIG. 9] A diagram plotting fractal dimensions of R, G, and B for each sample.

[FIG. 10] A diagram plotting fractal dimensions of Y, U, and V for each sample.

[FIG. 11] A diagram showing a relation between a visual evaluation value of beauty of a skin and a fractal dimension of a 3-dimensional skin surface relief value of a skin replica.

### BEST MODES FOR CARRYING OUT THE INVENTION

According to the present invention, a visual evaluation value of beauty of a skin means a statistical evaluation value indicating how beautiful the skin looks when it is seen by a person. Specifically, for example, the visual evaluation value is a statistical evaluation value obtained by repeatedly judging which of the skins looks more beautiful when a certain skin is compared with another skin. The beauty of the skin means the desirability of a skin condition when visually recognizable skin properties are put together. It means the desirability of the skin condition when properties such as fineness of microrelief, uniformity in a direction of microrelief, smoothness, an uneven feeling, a smooth feeling, a moist feeling, flexibility, wrinkles, suppleness, and shininess within a visually recognizable range are put together. Subjective beauty as obtained by processing information input from eyes through human mental activities is not included.

According to the present invention, the property value necessary for obtaining the visual evaluation value of beauty of a skin is at least one selected from image signals of a color system of images of a skin surface and a 3-dimensional skin surface relief value of a skin surface.

Examples of the image signals of the color system are RGB value, YUV value, Munsell (HVC) value, L*a*b* value, L*C*h* value, Lab value, and Yxy value. Among those values, especially RGB value, YUV value, and Munsell (HVC) value are preferably used. RGB value represents colors by a combination of three primary colors of a light, i.e., red (R), green (G), and blue (B). For example, in the case when each primary color represents 256 tones, about 16,770,000 of color tones can be represented by RGB value. YUV value represents colors by a combination of luminance (Y), a color difference (U=blue−Y), and a color difference (V=red−Y). Munsell (HVC) value is a JIS color system for representing colors by three components of a hue, brightness, and saturation. At least one component of the image signals of such a color system may be used as a property value, or a plurality of components may be used as a property value.

The 3-dimensional skin surface relief value is a numerical value indicating how high a point covering a surface of a certain target is from a reference surface.

To obtain an image signal of at least one color system of images of a skin surface, a skin surface of a test subject is first imaged. There is no limitation on a location of a skin to obtain an image as long as it is a part for estimating a visual evaluation value of beauty of a skin. A face skin such as a cheek, or an inner side of an upper arm may be used. For example, when an estimated visual evaluation value is used for selecting cosmetics such as a foundation or a rouge for cheek, cheeks are preferably imaged. Normally, an area representing a skin of the test subject is preferably selected to prevent a part with skin roughness or many freckles.

There is no limitation on a range for obtaining an image as long as it enables acquisition of necessary information. However, a preferable range is 1 cm*1 cm to 3 cm*3 cm of a skin surface.

There is no limitation on means for obtaining an image signal of at least one color system of images of the skin surface. For example, the image signal can be obtained by using a device such as a color digital microscope, a color digital camera, a color video camera, or a scanner. Such a device may be selected from those commercially available, or manufactured. Preferable examples of commercially available devices are an i-scope and a CCD microscope manufactured by Molitex Corporation, a USB video microscope manufactured by Fortissimo Corporation, and a digital microscope manufactured by Keyence Corporation.

An imaging magnification may be set to be suitable for a device used for imaging. For example, in the case of using a digital camera equipped with a macrolens, a proximate photographic image is preferably obtained by an equal magnification at a distance of about 20 cm from a target. In the case of using a video microscope (e.g., i-scope manufactured by Molitex Corporation), a skin is preferably enlarged by about 30 times to 50 times to be imaged. An information amount when the image is obtained in this manner may be 64*64 pixels (dots, pixels) or more, preferably 128*128 pixels or more, and more preferably 300*300 pixels or more, when converted into a range of 2 cm*2 cm.

The image signal of the color system thus obtained is preferably subjected to noise removal using a median filter or smoothing using a smoothing filter after it is transferred to a computer. Especially the smoothing is preferable. Smoothing enables correction of great variance in property values of images, whereby a fractal dimension can be calculated more accurately.

Image capturing and smoothing can be carried out by using commercially available image analysis software. Examples are WinROOF (registered trademark) manufactured by Mitani Corporation, AdobePhotoshop (registered trademark) manufactured by Adobe Systems Corporation (USA), and NanoHunter NS2K-Pro (registered trademark) manufactured by Nanosystem Corporation. In addition, smoothing software made public through Internet can be used. A preferable mask size is, for example, 3*3 or 5*5.

A specific image signal can be converted into another optional image signal through a common procedure. For example, YUV value, L*a*b* value, L*C*h* value, Lab value, and Yxy value can be obtained by conversion from RGB value by using conversion equations. For conversion into Munsell (HVC) value, conversion table can be used. For example, in the case of conversion from RGB value into YUV value, by using commercially available software, RGB value is subjected to γ correction, and then can be converted into YUV value by using, for example, an equation (A) below. In the case of conversion from RGB value into Munsell value, by using commercially available software or software made public through the Internet, RGB value is converted into XYZ value, and then can be converted into HCV of the Munsell color system.

[Equation 1]

$$[ \begin{matrix}Y \\ U \\ V\end{matrix} ] = [ \begin{matrix}0.297 & 0.587 & 0.114 \\ - 0.169 & - 0.331 & 0.500 \\ 0.500 & - 0.419 & - 0.081\end{matrix} ] [ \begin{matrix}R \\ G \\ B\end{matrix} ] \qquad ( A )$$

For a numerical value of at least one of components of the obtained image signal of the color system, fractal analysis is carried out to calculate a fractal dimension of a distribution of the numerical value in the image. A method of calculating a fractal dimension will be described below.

As a method of obtaining a 3-dimensional skin surface relief value of a skin surface, a method of obtaining a replica of a skin of a test subject, and using a 3-dimensional skin surface relief value obtained by measuring a surface shape of the replica may be used. There is no limitation on a region of a skin to obtain a replica as long as it is a part to estimate a visual evaluation value of beauty of a skin. A face surface such as a cheek or an inner side of an upper arm may be used. When an evaluation value is used for selecting cosmetics, a cheek replica is preferably obtained. For example, a measuring area of 2 cm*2 cm of a cheek region may be set to obtain a replica of a portion including this area. There is no limitation on replica agents. For example, Silicon ASB-01-WW manufactured by Asahi Biomethod Corporation may be used. Collection of replicas can be carried out through a common procedure used for diagnosing a skin contour. For example, a replica agent is applied to a skin left at a temperature of 20° C. and humidity of 50% for about 20 minutes after face washing to obtain the replica.

A 3-dimensional skin surface relief value of the created replica is measured as follows. There is no limitation on a method of measuring a 3-dimensional skin surface relief value. A normal method can be used. For example, “Wrinkle Evaluation Method Guidance”, Journal of Japanese Cosmetic Science Society, additional volume, Vol. 28, No. 2 (2004), can be referred to.

Specifically, for example, by using a commercially available laser-type three-dimensional surface roughness gauge, a part of a face shown in FIG. 5 can be measured by scanning it with a laser beam in horizontal and vertical directions X and Y. Examples of the three-dimensional roughness gauge are a high-accuracy three-dimensional image processing device LIP (e.g., LIP-50) manufactured by Science Systems Corporation, SURFCOM manufactured by Tokyo Seimitsu Co. Ltd., VLH manufactured by Laser Tech Corporation, PRIMOS (manufactured by GFM), and derma-TOP-blue (manufactured by Breuckmann).

There is no limitation on a scanning interval when an 3-dimensional skin surface relief value is measured by using the aforementioned devices as long as it is a range for obtaining sufficient data to calculate a fractal dimension. However, scanning is preferably carried out at an interval of 10 μm or less.

For example, when scanning is carried out by using the LIP-50, 1,000 parts of a replica area in which X*Y is 1 cm*1 cm can be scanned at an interval of 10 μm in an X or Y direction.

When acquiring the 3-dimensional skin surface relief value thus obtained, if sampling cycles are different between X and Y directions, the sampling cycles are preferably corrected by using the Sinc function (refer to FIG. 8).

A 3-dimensional skin surface relief value can also be obtained by a method of applying an oblique light to a replica using a light projection device, and extracting a shade part of a replica convex portion to measure a depth of a concave part and an area rate from its area, its width, or the like. The acquisition of the 3-dimensional skin surface relief value by applying the oblique light is preferable in that it is easy. For example, acquisition of the 3-dimensional skin surface relief value by this method can be carried out by using a reflection 3D replica analysis system (Asahi Bio Method) or the like.

A 3-dimensional surface relief value of a replica can be obtained by applying a light to a semitransparent replica to obtain a thickness of the replica based on the amount of a transmitted light (semitransparent replica light transmission method). For example, acquisition of the 3-dimensional skin surface relief value by this method can be carried out by using a 3D skin analysis system ASA-03 (Asahi Bio Method) or the like.

A 3-dimensional skin surface relief value may be obtained directly from a skin. An example of such a method is a method of applying a lattice light to the skin to convert a refractive index of the light into a 3-dimensional skin surface relief value. A commercially available device can be used. By using a device such as PRIMOS (manufactured by GFM Corporation) or derma-TOP-blue (manufactured by Breuckmann Corporation), 3-dimensional skin surface relief values can be obtained not only from the replica but also directly from the skin.

The 3-dimensional skin surface relief value of the skin surface obtained in this manner is subjected to fractal analysis to calculate a distribution of the 3-dimensional skin surface relief value of the skin in a measured area, in other words, a fractal dimension of a shape of the skin surface.

As a method of calculating a fractal dimension based on the obtained image signal of the color system or 3-dimensional skin surface relief value, a box-counting method, a correlation dimension method, or a fractional Brownian motion model method may be used. Especially, the box-counting method is preferable.

The box-counting method is a method of dividing a square (cube) completely covering a target into squares (cubes) of optional sizes, and obtaining a fractal dimension based on a relation between a size of the square (cube) and the number of divided squares (cubes) covering parts of the target, and generally used for calculating a fractal dimension.

Specifically, when the number of squares (cubes) covering parts of a target when a square (cube) completely covering the target is divided with a length of one side set to h is N(h), if the following approximate equation is established with good correlation between h and N(h), the target is a fractal shape, and D of the equation (1) is a fractal dimension.

N(h)=c·h⁻D (c is a fixed coefficient) (1)

Accordingly, to obtain a fractal dimension D by the box-counting method, c·h and N(h) are subjected to logarithmic plotting to calculate slope of an obtained straight line.

The box-counting method is very simple, and high-speed processing can be carried out by a computer. However, the farther a fractal dimension of a target is from a half-integral value, the lower its analysis accuracy becomes. Thus, a method of deciding a box size in the general box-counting method based on a standard deviation of a property value in the box is preferably used. In other words, a method which comprises not only the step of simply determining whether or not a part of the target is in the box but also the step of deciding an effective box size based on a standard deviation of data in the box to determine whether or not a part of the target is in the box is preferably used.

Such calculation of a fractal dimension can be carried out by the following specific method.

(1) First, as shown in FIG. 1, two-dimensional discrete data f (x, y) present in a size X×Y is divided into areas Si (x, y) of sizes h×h (m pieces). The discrete data present in the size X×Y is a pixel when an image signal is used, and data of a height from a reference surface when a 3-dimensional skin surface relief value is used. And h can be optionally decided.

(2) For the areas S₁ to Sₘ, standard deviations σ₁ to σₘ of property values are calculated by the following equation (2) (refer to FIG. 2).

[Equation 2]

$${σ}_{i} = \sqrt{\frac{1}{n} {\sum }_{j = 1}^{n} {( {f}_{j} - \overline{f} )}^{2}} \qquad ( 2 )$$

n: Number of data of area S (h×h) fⱼ: Data value at a point j when area S is subjected to raster scanning
f̅: Average of data in area S

(3) N(h) in a size h is calculated by the following equation (3).

[Equation 3]

$$N ( h ) = \frac{X \cdot Y}{{h}^{2}} \times \frac{σ}{h} = {\sum }_{i = 1}^{m} \frac{{σ}_{i}}{h} \qquad ( 3 )$$

The calculation of N(h) enables counting of the number of boxes with the standard deviations in the area Si of h×h set as effective box sizes. Thus, an influence of accidental noise such as data measuring noise can be suppressed. In addition, a wide scaling range of nearly one to two digits which is essential to estimating a fractal dimension can be obtained.

(4) The size h is increased to divide the data f (x, y) again, and N(h) is similarly calculated through the procedure of (1) to (3).

(5) (4) is repeated until h=X or h=Y is established to calculate N(h).

(6) A fractal dimension D is calculated based on slope of a graph showing a relation between logN (h) and logh (refer to FIG. 3).

The correlation dimension method is a method, when correlation integration C (r) defined by the following equation (4) is scaled by an equation (B), of setting slope of a graph of logC (r) to log (r) as a correlation dimension (fractal dimension) D.

[Equation 4]

C(r)∝r^{D} (B)

[Equation 5]

$$C ( r ) = \frac{1}{N ( N - 1 )} {\sum }_{i = 1}^{n} {\sum }_{j = 1}^{n} H ( r - ‖ {x}_{i} - {x}_{j} ‖ ) i \neq j \\ H ( x ) \{ \begin{matrix}1 x \geq 0 \\ 0 x < 0\end{matrix} \qquad ( 4 )$$

By using the fractal dimension of the property value of the skin of the test subject obtained in this manner, a visual evaluation value of beauty of the skin is estimated. For this purpose, by a method below, a regression equation indicating a relation between a fractal dimension of a property value of a skin and a visual evaluation value of beauty of a skin is prepared in advance.

For example, the regression equation can be created by the following method. However, the creation is not limited to the method.

(1) At least one property value selected from image signals of color systems and a 3-dimensional skin surface relief value is obtained from skins in which skin conditions and ages are sufficiently distributed (will be called samples, hereinafter), and a fractal dimension of the distribution of the obtained property value in each sample is calculated. The acquisition of the property value and the calculation of the fractal dimension can be carried out by the same method as that described above. The number of samples used in this case is 30 or more, preferably 50 or more.

(2) A proper assessors is prepared to represent a third person, and the samples are presented so that the assessors can evaluate visual beauty of the skin. This evaluation may be absolute evaluation such as scoring. However, relative evaluation such as ranking in comparison with other samples is preferable to guarantee objectivity. In ranking, if there is no difference, an equal rank can be employed. To guarantee more objectivity, it is explained to the assessors that the evaluation is carried out only for visible skin elements. In this case, any proper assessors to represent a third person are employed irrespective of age or sex as long as one can understand a meaning of at least visual beauty of the skin. The number of assessors is usually 4 or more, preferably 10 or more.

(3) The work (2) is preferably repeated. The number of times of work may be properly adjusted based on the number of assessors or the like. To obtain an objective evaluation result, the evaluation is normally repeated three times or more, preferably four times or more, and more preferably five times or more.

(4) Next, a visual evaluation value of beauty of a skin is calculated for each sample. The visual evaluation value may be an obtained score itself, or when relative evaluation based on ranking is carried out, may be a rank itself or a score which is given to the samples in descending order of beauty of a skin. Such an evaluation value may be a total score or an average score for each sample. For example, when ranking is carried out for n samples, with a score of the i-th sample set as n−i+1, an average score of each sample can be obtained to be set as an evaluation value. A deviation value of each sample can be obtained from a sample average score and a standard deviation to be set as an evaluation value. These values can be divided at optional ranks to be set as evaluation values.

(5) At least one property value obtained in (1) and the evaluation value obtained in (4) are subjected to regression analysis to obtain a regression equation (prediction equation). In this case, when an image signal of a color system such as RGB value, YUV value, or Munsell (HVC) value is used as a property value, components of the image signal of the color system and the visible evaluation value of the beauty of the skin are preferably subjected to a multiple regression analysis to obtain a multiple regression equation, because a higher correlation can be obtained. Such regression analysis can be carried out through a common procedure. For example, the regression analysis can be carried out by using commercially available statistical processing software.

By substituting the numerically calculated fractal dimension of the distribution of the property value of the test subject for the regression equation indicating a correlation between a fractal dimension of a distribution of a property value corresponding to the aforementioned property value and a visual evaluation value of beauty of a skin, a visual evaluation value of beauty of the skin of the test subject can be estimated. The estimation value of the visual evaluation value of beauty of the skin thus obtained can be directly displayed as a numerical value. However, the estimation value is preferably processed into easily used data such as a deviation value or a predefined rank, because it can be easily used in counseling or advising. For example, values between minimum and maximum values of visual evaluation values of samples used in the creation of the regression equation used for estimating a visual evaluation value of beauty of a skin can be divided into any plurality of equal ranks, so the ranks can be displayed by alphabets or numerals, and can be displayed by words indicating a level of beauty of a skin.

On a regression straight line drawn by the regression equation, the fractal dimension of the test subject can be indicated, a position or a rank can be graphically displayed in a sample group, or an image for a photograph (refer to FIG. 6) or a stereogram (refer to FIG. 7) can be displayed. There is no limitation on a graphical displaying method. For example, data can be displayed in a display of a device or a printing medium.

According to the present invention, a device for estimating a visual evaluation value of beauty of a skin includes means for obtaining an image signal of at least one color system of an image of a skin surface, means for calculating a fractal dimension of a distribution in the image regarding at least one of components of the image signal of the color system, means for substituting the numerically calculated fractal dimension to calculate a visual evaluation value of beauty of the skin for a prepared regression equation indicating a relation between a fractal dimension of a distribution of the components and a visual evaluation value of beauty of a skin, and means for displaying the visual evaluation value.

For example, the device of the present invention for estimating a visual evaluation value can be configured as follows. The configuration below is only an example, and the invention is not limited to this configuration.

FIG. 4 is a hardware block diagram of a device for estimating a visual evaluation value of beauty of a skin by using a fractal dimension of a color system image signal or a 3-dimensional skin surface relief value obtained from a surface of the skin. As shown in FIG. 4, an evaluation device includes an input unit 1, a central processing unit (CPU) 2, a read-only memory (ROM) 3, a random access memory (RAM) 4, a magnetic disk device 5, a recording unit 6, an operation unit 7, and a display unit 8. Those components are interconnected via a bus. The input unit 1 is a device such as a color digital microscope, a color digital camera, a color video camera, or a scanner for inputting an image signal of at least one color system of an image of a surface of a skin, or a device such as a three-dimensional roughness gauge for measuring a 3-dimensional skin surface relief value of a surface of the skin. The input unit 1 may include one or both of means for obtaining an image signal and a device for obtaining a 3-dimensional skin surface relief value. The CPU 2 executes processes including data processing such as smoothing, calculation of a fractal dimension by a box-counting method or the like, and calculation of a visual evaluation value by using a regression equation, according to the program stored in the ROM 3. The ROM 3 stores programs needed by the evaluation device of the invention to function, and various regression equations necessary for visual evaluation. The RAM 4 temporarily stores parts of operation system (OS) programs and application programs executed by the CPU 2. The magnetic disk device 5 is used as an external memory of the RAM 4, and includes a recording unit 6. The operation unit 7 is operated when necessary data such as a predetermined command or a regression equation is input. For the display unit 8, any type may be used as long as an estimated value of an evaluation value can be displayed. Examples of the display unit 8 include a display device such as a cathode ray tube (CRT), a liquid display, or a plasma display, a voice output device such as a speaker, and an output device such as a printer.

The present invention may relate to a program for causing a computer, another device, or machine to execute some or all of the processes. According to the invention, such a program may be recorded in a recording medium readable by a computer or the like.

### EXAMPLES

Embodiments of the present invention will be described below in detail by referring to Examples. It should be noted that the scope of the present invention is not limited to this.

### Example 1

### Correlation Between RGB or YUV Values and Visual Evaluation Value of Beauty of Skin

By using cheek images of 39 females of 10's to 50's, multiple regression equations indicating a relation between components of RGB value and a visual evaluation value of beauty of a skin and a relation between components of YUV value and a visual evaluation value of beauty of a skin were obtained, respectively. In other words, for 39 females, 30 minutes after face washing, parts shown in FIG. 5 were photographed by using a commercially available digital camera (Nikon D100 60 mm Macrolens), center areas 15*15 mm (size 300*300 pixels) of photographed areas were extracted (refer to FIG. 6), and those parts were smoothed by 3*3 masks (grating values were all 1) (FIG. 7). YUV value was obtained by subjecting RGB value to matrix transformation through a common procedure. A fractal dimension was calculated by using a program for causing the computer to execute the box-counting method of calculating a fractal dimension for components of RGB and YUV values of each sample through the equations (2) and (3). In the box-counting method, with X=300 and Y=300, h is changed to 2, 4, 8, 16 . . . 2ⁿ to calculate N (h) for each h.

Based on a result of the calculation, logN (h) with respect to logh was plotted to obtain a fractal dimension for each sample.

Meanwhile, for the cheek photographs of 39 females (refer to FIG. 6), beauty of skins were visually evaluated by third persons. 6 panelists were selected as third persons, and the cheek photographs of 39 females were presented to be ranked in order of visual skin beauty. Such operations were independently carried out four times, and 40—(rank) when the photographed were arranged in order of visual beauty was set as a score. In other words, a score of a most beautiful photograph was 39, and a score of a least beautiful photograph was 1. Then, an average value of scores was calculated for each photograph to be set as a visual evaluation value of beauty of a skin.

Regarding the cheek photographs of 39 females, a fractal dimension was calculated for each component of RGB value obtained from a skin image. FIG. 9 shows plotting of a fractal dimension of each component in a three-dimensional coordinate space which includes three axes of RGB components. Accordingly, it can be understood that there is a positive correlation among fractal dimensions of three components of RGB.

Subsequently, the visual evaluation value of beauty of the skin obtained above was set as a objective variable, and regression analysis was carried out by using R, G, and B as explanatory variables. As a result, partial correlation coefficients between the visual evaluation value and R, G, and B were 0.835, 0.877, and 0.896, exhibiting a high correlation.

Subsequently, the visual evaluation value (y) of beauty of the skin obtained above was set as a objective variable, and a multiple regression analysis was carried out by using three components (x_{R}, x_{G}, x_{B}) of RGB as explanatory variables. An obtained multiple regression equation was y=88.8*x_{R}−126.4*x_{G}−224.4*x_{B}−469.7, and a correlation coefficient was 0.907 (P<0.01).

FIG. 10 shows plotting of a fractal dimension of each component in a three-dimension coordinate space which includes three axes of components of YUV obtained by converting the RGB value obtained from the skin image into YUV value by using the aforementioned method to calculate a fractal dimension of each component of YUV for the cheek photographs of 39 females. Accordingly, it can be understood that there is a positive correlation among fractal dimensions of three components of the YUV.

Subsequently, the visual evaluation value of beauty of the skin obtained above was set as a objective variable, and regression analysis was carried out by using Y, U, and V as explanatory variables. As a result, partial correlation coefficients between the visual evaluation value and Y, U, and V were 0.893, 0.864, and 0.888, exhibiting a high correlation.

Subsequently, the visual evaluation value (y) of beauty of the skin obtained above was set as a objective variable, and a multiple regression analysis was carried out by using three components (x_{Y}, x_{U}, x_{V}) of YUV as explanatory variables. An obtained multiple regression equation was y=95.0*x_{Y}+36.2*x_{U}+45.8*x_{V}−441.4, and a correlation coefficient was (P<0.01).

### Example 2

### Estimation of Visual Evaluation Value of Beauty of Skin Using YUV Value

Targeting cheek photographs of 248 subjects of 10's to 50's, a fractal dimension of YUV value was calculated by the aforementioned method, and scores of beauty of skins were obtained as in the case of Example 1. Then, deviation values were obtained to be set as visual evaluation values, and the visual evaluation values (y) and respective components (x_{Y}, x_{U}, x_{V}) of YUV were subjected to a multiple regression analysis to obtain a multiple regression equation. The obtained multiple regression equation was y=70.3*x_{Y}+32.0*x_{U}+15.2*x_{V}−256.6, and a multiple correlation coefficient was 0.909 (p<0.01).

Next, YUV values were obtained from cheek photographs of 5 female test subjects not included in 248 people, and a fractal dimension of each component of YUV was calculated for each photograph. The numerically calculated fractal dimension (x_{Y}, x_{U}, x_{V}) were substituted for the multiple regression equation to calculate visual evaluation values (y) of skins.

Visual evaluation values of the cheek photographs of 5 female test subjects were obtained as in the case of the aforementioned method, and results were compared. Table 1 shows a result. It can be understood that an estimated value of a visual evaluation value of beauty of a skin using a fractal dimension and a visual evaluation value of beauty of a skin agree extremely well.

[Table 1]

TABLE 1

| | | | Visual |
|---|---|---|---|
| | | Estimated | evaluation |
| | Age | value | value |
| A | 22 | 76 | 70 |
| B | 22 | 70 | 65 |
| C | 35 | 53 | 51 |
| D | 38 | 51 | 49 |
| E | 52 | 44 | 43 |

### Example 3

### Estimation of Visual Evaluation Value of Beauty of Skin Using 3-Dimensional Skin Surface Relief Value

For 39 females whose cheek photographs were obtained in Example 1, replica samples of skins of centers 2 cm*2 cm were collected from the cheeks shown in FIG. 5 by using commercially available silicon. Then, 3-dimensional skin surface relief value data was obtained by using a high-accuracy three-dimensional image processing device LIP-50 manufactured by Science Systems Corporation. For an area of a center 1 cm*1 cm of the replica, 1000 parts were scanned at an interval of 10 μm in y direction (longitudinal direction). In the case of the LIP-50, sampling frequencies differ between x and y directions, i.e., 9.4 μm and 10 μm, respectively. Thus, by using the Sinc function, supplemental processing was executed to realize spaces of 10 μm in both x and y directions, and then a fractal dimension was calculated as in the case of the Example 1 (FIG. 3).

The visual evaluation values (y) of beauty of the skins of the cheek photographs of 39 females obtained in the Example 1 and the fractal dimensions (x) calculated from the 3-dimensional skin surface relief were subjected to regression analysis. FIG. 11 shows a correlation between them. An obtained regression equation was y=63.2*x−127.2, and a correlation coefficient was 0.912 (p<0.01), exhibiting a significant and high correlation.

Then, a fractal dimension was calculated from a 3-dimensional skin surface relief value obtained from a replica sample of a cheek of a 33-year old female test subject as in the aforementioned case. The fractal dimension was substituted for the regression equation to estimate a visual evaluation value of beauty of a skin. A fractal dimension of the 3-dimensional skin surface relief value obtained from the replica sample of this female test subject was D=2.32, and an estimated value of a visual evaluation value of beauty of the skin was 19.4. Visual evaluation was separately executed for beauty of the skin, and an evaluation value was 20. The estimation value of a visual evaluation value of beauty of the skin and the actual visual evaluation value agree well.

### INDUSTRIAL APPLICABILITY

Through the method and the device of the present invention, skin evaluation can be carried out easily, objectively, and quantitatively by using various skin property values.

According to the present invention, the visual beauty of a skin seen by a third person can be identified objectively and easily, so anybody can estimate a visual evaluation value of skin beauty of a test subject. By using the method and the device of the present invention, it is possible to provide skin counseling and proper information on site such as advice on skin care treatment and selection of cosmetics.

1. A method of estimating a visual evaluation value of skin beauty, comprising the steps of:
obtaining an image signal of at least one color system of an image of a skin surface;
calculating a fractal dimension of a distribution of at least one components of the image signal of the color system in the image; and
substituting the numerically calculated fractal dimension for a prepared regression equation indicating a relationship between a fractal dimension of a distribution of the component and a visual evaluation value of skin beauty to obtain the visual evaluation value of skin beauty.

2. The method according to claim 1, wherein the image signal of the color system is one selected from RGB value, YUV value, and Munsell (HVC) value.

3. The method according to claim 2, wherein the regression equation is obtained by subjecting the fractal dimension of the distribution of each component of one selected from RGB value, YUV value, and Munsell (HVC) value and the visual evaluation value of skin beauty to a multiple regression analysis.

4. A method of estimating a visual evaluation value of skin beauty, comprising the steps of:
obtaining a 3-dimensional skin surface relief value of the skin;
calculating a fractal dimension of a distribution of the 3-dimensional skin surface relief value; and
substituting the numerically calculated fractal dimension for a prepared regression equation indicating a relationship between a fractal dimension of a distribution of the 3-dimensional skin surface relief value and a visual evaluation value of skin beauty to obtain a visual evaluation value of skin beauty.

5. The method according to claim 1, wherein the fractal dimension is calculated by a box-counting method.

6. The method according to claim 5, wherein a box size in the box-counting method is decided based on a standard deviation of at least one components constructing the image signal of the color system in the box or the 3-dimensional skin surface relief value.

7. A device for estimating a visual evaluation value of skin beauty, comprising:
means for obtaining an image signal of at least one color system of an image of a skin surface;
means for calculating a fractal dimension of a distribution of at least one components of the image signal of the color system in the image;
means for substituting the numerically calculated fractal dimension for a prepared regression equation indicating a relation between a fractal dimension of a distribution of the component and a visual evaluation value of skin beauty to calculate a visual evaluation value of beauty of the skin; and
means for displaying the calculated visual evaluation value.

8. A device for estimating a visual evaluation value of skin beauty, comprising:
means for obtaining a 3-dimensional skin surface relief value of the skin;
means for calculating a fractal dimension of a distribution of the 3-dimensional skin surface relief value;
means for substituting the numerically calculated fractal dimension for a prepared regression equation indicating a relation between a fractal dimension of a distribution of the 3-dimensional skin surface relief value and a visual evaluation value of skin beauty to calculate the visual evaluation value of skin beauty; and
means for displaying the calculated visual evaluation value.

9. A program for estimating a visual evaluation value of skin beauty, causing a computer to function as:
means for calculating a fractal dimension of a distribution of at least one component of an image signal of a color system of an image of a surface of a skin in the image; and
means for substituting the numerically calculated fractal dimension for a prepared regression equation indicating a relation between a fractal dimension of a distribution of the component and a visual evaluation value of skin beauty to calculate a visual evaluation value of skin beauty.

10. A program for estimating a visual evaluation value of skin beauty, causing a computer to function as:
means for calculating a fractal dimension of a distribution of a 3-dimensional skin surface relief value of the skin; and
means for substituting the numerically calculated fractal dimension for a prepared regression equation indicating a fractal dimension of a distribution of the 3-dimensional skin surface relief value and a visual evaluation value of skin beauty to calculate the visual evaluation value of skin beauty.
